(19) United States
(12) Patent Application Publication
(10) Pub. No.: US 2025/0369794 A1
(43) Pub. Date: Dec. 4, 2025

(54) VIBRATION DETECTION DEVICE

(71) Applicant: HOSIDEN CORPORATION, Osaka (JP)

(72) Inventors: Hiroki NIHO, Osaka (JP); Koki MAEDA, Osaka (JP)

(73) Assignee: HOSIDEN CORPORATION, Osaka (JP)

(21) Appl. No.: 19/213,134

(22) Filed: May 20, 2025

(30) Foreign Application Priority Data
May 30, 2024 (JP) 2024-087756

(51) Int. Cl. G01H 9/00; H04R 1/02

(52) U.S. Cl. CPC G01H 9/00; H04R 1/02

(57) ABSTRACT

A vibration detection device includes a housing, a substrate, a case, a detection element, a metal foil, and a sealing member. The housing includes a first opening portion and a second opening portion which is formed on a bottom surface of the first opening portion in a manner to open smaller than the first opening portion. The substrate is fixed to the bottom surface of the first opening portion to close the second opening portion. The case is fixed on a back surface of the substrate and is accommodated in the second opening portion with a bottom surface thereof opened. The detection element is fixed on the back surface of the substrate and is accommodated in the case. The metal foil is attached to the case to lid the bottom surface of the case. The sealing member seals the first opening portion.

### TECHNICAL FIELD

The present invention relates to a vibration detection device.

### BACKGROUND ART

For example, Japanese Patent Application Laid Open No. 2021-9131 (hereinafter, referred to as Patent Literature 1) has been disclosed as an example of a vibration detection device of prior art.

The vibration detection device of Patent Literature 1 is provided to improve accuracy in detecting vibration of an object device, and includes a printed circuit board on which a vibration sensor detecting the vibration of the object device is mounted, and a sensor case accommodating the printed circuit board. A surface of the printed circuit board opposed to the object device is in contact with the sensor case at a position on the opposing surface facing the vibration sensor with the printed circuit board interposed therebetween.

In vibration measurement for mechanical equipment, a vibration detection device may be subjected to an impact vibration, which may damage internal elements of the vibration detection device.

### SUMMARY OF THE INVENTION

An object of the present disclosure is to provide a vibration detection device whose internal elements are not easily damaged even when an impact vibration is applied.

A vibration detection device according to the present disclosure includes a housing, a substrate, a case, a detection element, a metal foil, and a sealing member.

The housing includes a first opening portion and a second opening portion which is formed on a bottom surface of the first opening portion in a manner to open smaller than the first opening portion. The substrate is fixed to the bottom surface of the first opening portion to close the second opening portion. The case is accommodated in the second opening portion and is fixed on a back surface of the substrate with a bottom surface thereof opened. The detection element is accommodated in the case and is fixed on the back surface of the substrate. The metal foil is attached to the case to lid the bottom surface of the case. The sealing member seals the first opening portion.

### Effects of the Invention

According to the vibration detection device of the present disclosure, the internal elements are not easily damaged even when an impact vibration is applied.

### BRIEF DESCRIPTION OF THE DRAWINGS

FIG. 1 is a sectional view illustrating a vibration detection device according to a first embodiment.

FIG. 2 is a sectional view illustrating a housing of the vibration detection device according to the first embodiment.

### DETAILED DESCRIPTION

An embodiment according to the present disclosure will be described in detail below. Here, components having the mutually-same functions will be provided with the mutually-same reference numerals and duplicate description thereof will be omitted.

### First Embodiment

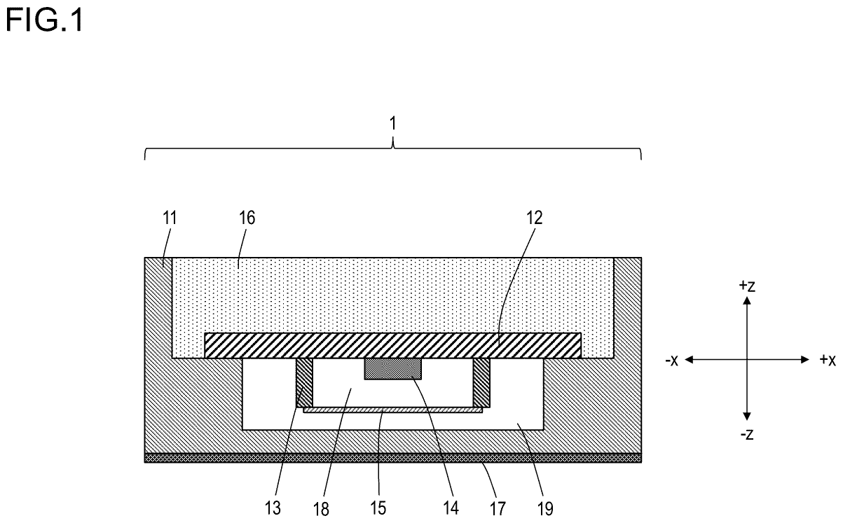

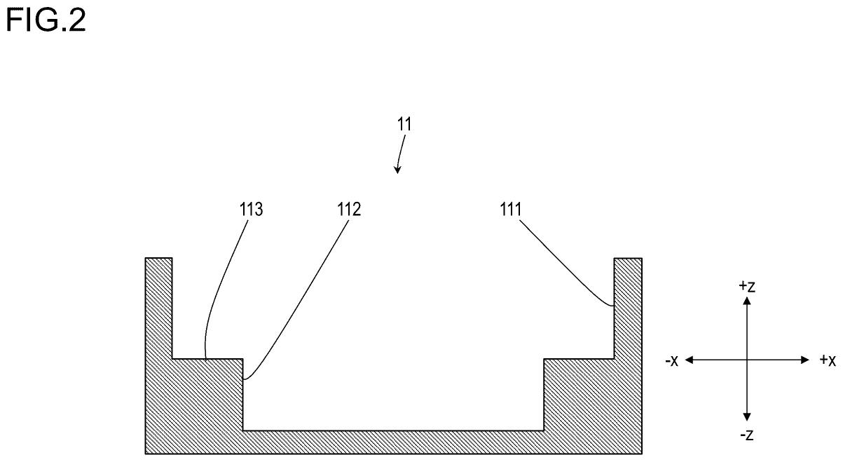

A structure of a vibration detection device according to a first embodiment will be described with reference to FIGS. 1 and 2. As illustrated in FIG. 1, a vibration detection device 1 of the present embodiment includes a housing 11, a substrate 12, a case 13, a detection element 14, a metal foil 15, a sealing member 16, and a magnet 17.

In this specification, an upward direction refers to a +z direction illustrated in the drawing, and a downward direction refers to a −z direction illustrated in the drawing. Further, a front surface of each component means a surface of the component on the +z direction side, and a back surface means a surface of the component on the −z direction side. Furthermore, a direction which is orthogonal to the +z/−z direction and is on the right of the drawing is defined as a +x direction, and a direction on the left of the drawing is defined as a −x direction. A direction which is orthogonal to both of the +z/−z direction and the +x/−x direction and is toward the back of the drawing is defined as a +y direction, and a direction toward the front of the drawing is defined as a −y direction.

### <Housing 11>

As illustrated in FIG. 2, a first opening portion 111 is formed in a manner to bore a front surface of the housing 11. A second opening portion 112 which opens smaller than the first opening portion 111 is formed in a manner to bore the center of a bottom surface 113 of the first opening portion 111. Here, it should be noted that the second opening portion 112 does not penetrate through to a back surface of the housing 11.

Thus, the housing 11 has a box-like shape having a recessed portion including a step such that a peripheral edge portion has a first depth L1 and a central portion has a second depth L2 (>L1). The housing 11 is preferably made of a resin material which has high rigidity and whose Young's modulus is equal to or higher than a predetermined value. By using the resin material with high rigidity for the housing 11, unwanted resonance in a measurement range can be prevented. The back surface of the housing 11 may be formed unevenly to match a shape of an object to be detected (object to be measured) and a circumference may be fixed with an adhesive.

### <Substrate 12>

The substrate 12 has a flat plate shape, and a peripheral edge portion of the back surface of the substrate 12 is fixed to the bottom surface 113 of the first opening portion 111 to close the second opening portion 112. This makes it difficult for ambient noise to affect the inside of the second opening portion 112.

### <Case 13>

The case 13 is accommodated in the second opening portion 112 and is fixed on the back surface of the substrate 12, and a portion or the whole of the bottom surface of the case 13 is opened.

Even if an impact or high G-acceleration is momentarily applied during vibration measurement, a direct load is not applied to the detection element 14 and the metal foil 15, which are important components in the vibration measurement, but only an indirect load is applied to the detection element 14 and the metal foil 15 through the substrate 12 and the case 13. Accordingly, the internal elements are not easily damaged.

### <Detection Element 14>

The detection element 14 is accommodated in the case 13 and is fixed on the back surface of the substrate 12. The detection element 14 may be, for example, a microphone. When the detection element 14 is a microphone, a cable is wired to the substrate 12 to extract a microphone output and a circuit is provided to amplify the microphone output. The use of a microphone as the detection element 14 can advantageously reduce the cost.

In addition, the detection element 14 can be a combination of a light emitting element, which emits a reference light, and a light receiving element, so as to be able to optically detect vibration displacement of the metal foil 15.

### <Metal Foil 15>

The metal foil 15 is attached to the back surface of the case 13 to lid the bottom surface of the case 13. Here, the metal foil 15 may be formed by laminating a metal foil on a resin film or coating a resin film with a metal foil.

The vibration detection device 1 of the present embodiment can be applied to any physical phenomenon which generates vibrations in the metal foil 15. Changes in external magnetic fields can be detected, for example, by selecting a magnetic material as the metal foil 15 or laminating the magnetic material on the metal foil 15 or coating the metal foil 15 with the magnetic material.

The use of the metal foil 15 as a diaphragm makes the diaphragm stronger and less prone to be damaged. Further, by using the metal foil 15 for the diaphragm, a resonance frequency can be set high even though the metal foil 15 is in a foil shape, and a certain level of sensitivity can be obtained for vibrations in a band lower than the resonance frequency. Furthermore, the metal foil 15 is lightweight and is therefore sufficiently displaced even by indirect vibration through the housing 11, the substrate 12, and then the case 13, being able to ensure sensitivity.

The metal foil 15 is preferably welded and fixed to the case 13. This is because the welding can firmly fix the metal foil 15 to the case 13, thereby increasing durability against impacts and the like.

### <Sealing Member 16>

The sealing member 16 is filled from the front surface side of the housing 11 to seal the first opening portion 111. The second opening portion 112 is closed by the substrate 12 and therefore not filled with the sealing member 16.

The sealing member 16 is preferably a material having a hardness to be classified as hard rubber or a material having a Shore D hardness of 80 or greater.

Even when an impact is applied to the vibration detection device 1, the sealing member 16 absorbs a load on the detection element 14 and the metal foil 15, making the detection element 14 and the metal foil 15 difficult to be damaged. Further, the sealing member 16 further attenuates ambient noise, reducing an effect on the detection element 14. Furthermore, the sealing member 16 can suppress an occurrence of unwanted resonance modes in the housing 11 and the substrate 12. The substrate 12 is sealed by the sealing member 16, which can make the vibration detection device 1 waterproof and dustproof.

### <Magnet 17>

As illustrated in FIG. 1, it is preferable that the magnet 17 for connection with an object to be detected (object to be measured) is provided on a surface of the housing 11 (back surface or side surface) which is different from the surface (front surface) on which the first opening portion 111 is formed.

As a structure other than the magnet, for example, a female screw structure or a male screw structure for the connection with an object to be detected (object to be measured) may be provided on a surface of the housing 11 (back surface or side surface) which is different from the surface (front surface) on which the first opening portion 111 is formed.

The magnet 17, the female screw structure, and the male screw structure do not have to be separate parts from the housing 11, but may be formed to be integrated with the housing 11.

The vibration detection device 1 can be easily attached to an object to be detected (object to be measured) by the magnet 17, the female screw structure, and the male screw structure.

### <First and Second Closed Spaces 18 and 19>

As described above, the second opening portion 112 is closed by the substrate 12. The second opening portion 112 is divided into a first closed space 18 and a second closed space 19.

The first closed space 18 is a space which is inside the case 13 and is surrounded by the substrate 12, the case 13, and the metal foil 15. The detection element 14 is arranged inside the first closed space 18.

The second closed space 19 is a space which is outside the case 13 and is surrounded by the housing 11, the substrate 12, the case 13, and the metal foil 15.

### <Principle of Operation of Detection Element 14>

When a bottom surface of the housing 11 of the vibration detection device 1 is fixed to an object to be detected (object to be measured), the vibration of the object to be detected (object to be measured) is propagated through the housing 11, the substrate 12, and the case 13 to the metal foil 15. When the metal foil 15 is displaced in response to the vibration, a pressure change is generated in the first closed space 18. The pressure change generated in the first closed space 18 can be detected by the detection element 14.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A vibration detection device comprising:
a housing which includes a first opening portion and a second opening portion, the second opening portion being formed on a bottom surface of the first opening portion in a manner to open smaller than the first opening portion;
a substrate which is fixed to the bottom surface of the first opening portion to close the second opening portion;
a case which is accommodated in the second opening portion and is fixed on a back surface of the substrate with a bottom surface thereof opened;
a detection element which is accommodated in the case and is fixed on the back surface of the substrate;
a metal foil which is attached to the case to lid the bottom surface of the case; and
a sealing member which seals the first opening portion.

2. The vibration detection device according to claim 1, wherein
the metal foil is welded and fixed to the case.

3. The vibration detection device according to claim 1, wherein
the sealing member is a material having a hardness to be classified as hard rubber.

4. The vibration detection device according to claim 1, wherein
the sealing member is a material having a Shore D hardness of 80 or greater.

5. The vibration detection device according to claim 1, wherein
the detection element is a microphone.

6. The vibration detection device according to claim 1, wherein
the detection element is a combination of a light emitting element and a light receiving element, the light emitting element emitting a reference light.

7. The vibration detection device according to claim 1, wherein
the housing is made of resin whose Young's modulus is equal to or higher than a predetermined value.

8. The vibration detection device according to claim 1, further comprising:
a magnet on a surface of the housing, the surface being different from a surface on which the first opening portion is formed.

9. The vibration detection device according to claim 1, further comprising:
a female screw structure on a surface of the housing, the surface being different from a surface on which the first opening portion is formed.

10. The vibration detection device according to claim 1, further comprising:
a male screw structure on a surface of the housing, the surface being different from a surface on which the first opening portion is formed.
